(19) United States
(12) Patent Application Publication
(10) Pub. No.: US 2009/0154354 A1
(43) Pub. Date: Jun. 18, 2009

(54) PROXY REACTION ENGINE IN A CONGESTION MANAGEMENT SYSTEM

(75) Inventors: Bruce Kwan, Sunnyvale, CA (US); Mohan Kalkunte, Saratoga, CA (US)

Correspondence Address: BRAKE HUGHES BELLERMANN LLP;c/o CPA Global, P.O. Box 52050, Minneapolis, MN, 55402, US

(73) Assignee: Broadcom Corporation, Irvine, CA (US)

(21) Appl. No.: 12/334,341

(22) Filed: Dec. 12, 2008

Related U.S. Application Data
(60) Provisional application No. 61/013,867, filed on Dec. 14, 2007.

(51) Int. Cl. H04L 12/56

(52) U.S. Cl. 370/235

(57) ABSTRACT

An apparatus comprising a managed network interface configured to receive data from, and transmit data to, a managed network, wherein the managed network comprises a plurality of managed devices configured to queue and transmit data; an unmanaged network interface configured to receive data from, and transmit data to, an unmanaged network, wherein the unmanaged network is configured to request the amelioration of network congestion experienced by the unmanaged network; and a congestion manager configured to receive a network congestion amelioration request from the unmanaged network, ameliorate network congestion by controlling the rate of information forwarded from the managed network to an unmanaged network, and dynamically alter the rate of information forwarded from the managed network to the unmanaged network.

### CROSS-REFERENCE TO RELATED APPLICATION

This application claims priority to U.S. Provisional Application No. 61/013,867, filed on Dec. 14, 2007, entitled “Proxy Reaction Engine In A Congestion Management System”, which is incorporated by reference herein in its entirety.

### TECHNICAL FIELD

This description relates to the routing of information in a network, and more specifically to the amelioration of network congestion.

### BACKGROUND

Routing, in this context, is generally the process of selecting a path for data to travel within a network or plurality of networks from a source to a destination. Typically, it involves selecting a sequence of network links to be traversed as data travels from device to device within a network. In this context, a link may be a physical, virtual, or wireless connection between two or more devices. In many instances, data may pass through or be handled by multiple intermediate devices between the original source of the data and the data's final destination.

Occasionally, a network route becomes congested. For example, too much data may attempt to traverse one or more intermediate nodes or devices. Typically, network congestion occurs when a link or node attempts to carry so much data that its quality of service deteriorates. Typical effects of network congestion include queuing delay, packet loss or the blocking of new connections. Exacerbating the problem, the originating devices may attempt to re-send data to ameliorate the deteriorating quality of service provided to the data. These re-sends may increase the congestion experienced by the network. In general, a stable state with low throughput or semi-gridlock may be known as congestive collapse.

### SUMMARY

A system and/or method for communicating information, substantially as shown in and/or described in connection with at least one of the figures, as set forth more completely in the claims, is disclosed.

### BRIEF DESCRIPTION OF THE DRAWINGS

FIG. 1 is a block diagram of an apparatus for the amelioration of congestion in a network in accordance with the disclosed subject matter.

FIG. 2 is a block diagram of a system for the amelioration of congestion in a network in accordance with the disclosed subject matter.

FIG. 3 is a flowchart of a technique for the amelioration of congestion in a network in accordance with the disclosed subject matter.

### DETAILED DESCRIPTION

A few attempts to ameliorate network congestion have been typically one-sided. For example, in one case involving a scheme referred to as “exponential back off” a transmitting device may realize that may not have been received by an intermediate or final device in the data route. In such a case, the transmitting device may refrain from transmitting additional data along the network route for a period of time. In some embodiments, the period of time may increase as the additional transmissions fail to result in receipt acknowledgement notices. The disclosed subject matter describes a cooperative scheme for the amelioration of network congestion.

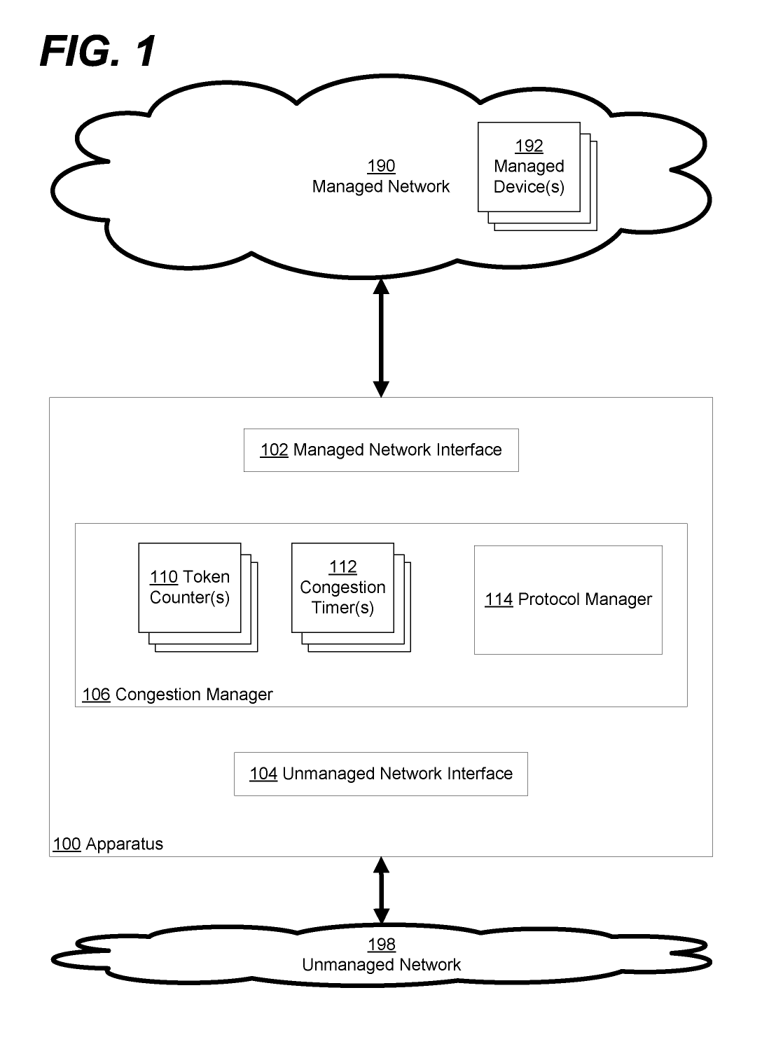

FIG. 1 is a block diagram of an apparatus for the amelioration of congestion in a network in accordance with the disclosed subject matter. In one embodiment, the apparatus or proxy reaction engine 100 may include a managed network interface 102, an unmanaged network interface 104, and a congestion manager 106. In some embodiments, the apparatus 100 may be configured to relay or forward information or data between a managed network 190 and an unmanaged network 198.

In this context, “managed” and “unmanaged” may refer to the relative level of control exercised by the apparatus 100 over the networks or devices. As discussed below, the apparatus 100 may manage or control (at least partly) the rate of information transmitted from the managed network 190 to the unmanaged network 198; therefore, the network 190 and devices 192 may be thought of as being managed by the apparatus 100. Conversely, in the context of the disclosed subject matter, the apparatus 100 may not attempt to significantly manage or control the flow of information from the unmanaged network 198 to the managed network 190; therefore, the network 198 may be thought of as being unmanaged from the perspective of the apparatus 100. Although it is understood that outside the context of the disclosed subject matter the apparatus 100 and the networks 190 and 198 may experience various controls and/or managements schemes.

In various embodiments, the managed network interface 102 may be configured to receive data from, and transmit data to, a managed network 190. In one embodiment, the managed network 190 may comprise a plurality of managed devices 192 configured to queue and transmit data. In some instances, the managed devices 192 may transmit data to an unmanaged network 198 via the apparatus 100. In one embodiment, the managed network, or portions thereof, may be configured to be managed by the apparatus 100.

In some embodiments, the unmanaged network interface 104 may be configured to receive data from and transmit data to an unmanaged network 198. In one embodiment, the unmanaged network 198 may be configured to request the amelioration of network congestion experienced by the unmanaged network 198.

In one embodiment, the congestion manager 106 may be configured to receive a network congestion amelioration request from the unmanaged network 198 via the unmanaged network interface 104. In such an embodiment, the network congestion amelioration request may be addressed to a managed device 192 or, in one embodiment, to the apparatus 100. In such an embodiment, the congestion manager may be configured to intercept and act upon the network congestion amelioration request addressed to the managed device 192.

In one embodiment, the congestion manager 106 may be configured to ameliorate or attempt to ameliorate network congestion by controlling the rate of information forwarded from the managed network 190 to the unmanaged network 198. In one embodiment, the congestion manager 106 may be configured to control or manage the rate of information transmitted from each of the plurality of managed devices 192 to the unmanaged network 198, as described below. In some embodiments, some or all of the managed devices 192 may be capable of adjusting the rate at which they transmit data or information. In these embodiments, the congestion manager 106 may be configured to work with the managed devices 192 to ameliorate the network congestion.

In one embodiment, the congestion manager 106 may be configured to perform this amelioration by dynamically altering the rate of information forwarded from the managed network 190 to the unmanaged network 198. In such an embodiment, the congestion manager 106 may be configured to dynamically alter the rate at which information is forwarded forwarded from each of the plurality of managed devices 192 to the unmanaged network 198. In one embodiment, the congestion manager 106 may be configured to modulate the data rates up and/or down so that a number of devices utilizing the unmanaged network 198 achieve or attempt to achieve some defined equilibrium wherein the apparatus 100 sends data such that the congestion is sufficiently managed so that network traffic or a queuing delay is low and/or predictable.

In one embodiment, the congestion manager 106 may comprise a plurality of token counters 110. In various embodiments, each token counter 110 may be associated with a particular managed device 192. Although it is understood that in some embodiments there may be more token counters 110 than managed devices 192 and that a one-to-one mapping may not be possible or desirable. In such an embodiment, some token counters 110 may be inactive.

In one embodiment, each token counter 110 may be configured to manage the rate of information or data forwarded from the token counter's respective managed device 192 to the unmanaged network 198. In certain embodiments, the token counter 110 may count how much information has been sent by the managed device 192 during a fixed period of time. In some embodiments, the fixed period of time may be a moving or rolling period of time; for example the counter may not reset at the end of every second, but instead the information sent more than a second ago may no longer be summed into the data count.

In one embodiment, the token counter 110 may include a threshold or limit configured to limit the rate of the information forwarded from the managed device 192 to the unmanaged network 198. In such an embodiment, as data is transmitted to the unmanaged network 198 the token counter 110 may increase the count. However, eventually, the count may reach or exceed the given threshold value. At such a time, in one embodiment, the congestion manager 106 may stop forwarding information from the managed device 192 to the unmanaged network 198. Although, it is understood that the above is merely an illustrative example of data rate limiting to which the disclosed subject matter is not limited.

In some embodiments, the token counter 110 may include both a full period based threshold and a burst based threshold. In one embodiment, the burst based threshold may be configured to allow a managed device 192 to transmit a relatively large amount of data in a short period of time; whereas the period based threshold may be configured to limit the overall amount of data transmitted during a larger time period. For example, in some embodiments, a managed device 192 may transmit a relatively large amount of data in a short burst, and then transmit little if any data for the rest of the given time period. In various embodiments, the default threshold of the token counter 110 may be preconfigured.

In various embodiments, the data or information may include a priority. In such an embodiment, the priority may be included in a header of the data. The priority may be associated with the data by the transmitting managed device 192. In one such embodiment, the plurality of token counters 110 may be associated with both a managed device 192 and a priority. As such, in one embodiment, each managed device 192 may be associated with a sub-set of the plurality of token counters 110, each token counter 110 of the sub-set associated with a different data priority. In various embodiments, the token counters 110 may be configured to limit the rate at which information having a particular priority is transmitted from the managed device 192. In such an embodiment, the congestion manager 106 may attempt to ameliorate the network congestion by reducing the data rate of the lowest priority information first, and, as needed, reducing the data rate of the subsequent higher priority information.

In one embodiment, the congestion manager 106 may be configured to dynamical alter the threshold of the token counter 110 based, at least in part upon, the congestion amelioration request from the unmanaged network 192. In such an embodiment, the congestion manager 106 may receive a congestion amelioration request. In one embodiment, the request may be directed to a particular managed device 192, group of managed devices, or the managed network 190 as a whole. In various embodiments, the congestion manager 192 may be configured to identify the token counters 110 associated with the objects of the request. In such an embodiment, the congestion manager 106 may lower the threshold value of the token counters 110 or the maximum data rate for the objects of the congestion amelioration request. Conversely, when the network is no longer congested or thought/suspected to no longer be congested, the congestion manager 106 may raise the threshold value of the token counters 110 or the maximum data rate for the objects of the congestion amelioration request.

In one embodiment, the congestion manager 106 may include a congestion timer 112. In some embodiments, the congestion timer 112 may be configured to measure a time between congestion amelioration requests from the unmanaged network 198. In various embodiments, the congestion manager 106 may include a plurality of congestion timers 112, wherein each congestion timer 112 is associated with a managed device 192, or in alternate embodiments a token counter 110 (which in turn may be associated with a managed device 192).

In one embodiment, the congestion timer 112 may be configured to count down from a certain or default value to zero (or a preset value). For example, in one embodiment, the congestion timer 112 may count down from one second. In one embodiment, if another congestion amelioration request associated with the congestion timer 112 is received, the congestion timer 112 may reset to its default value. In another embodiment, if congestion amelioration requests associated with the congestion timer 112 are received before the congestion timer 112 reaches zero, the congestion timer 112 may reset to increasingly higher values (e.g., one second, two seconds, four second, eight seconds, etc.). It is understood that in some embodiments, the congestion timer 112 may count up to the threshold as opposed to down from the threshold value.

In some embodiments, the congestion manager 106 may be configured to, once a congestion timer 112 has reached a threshold value (e.g., down to zero from the threshold value or up from zero to the threshold value), reset the data rate of information forwarded from the respective managed device 192 to the unmanaged network 198. In such an embodiment, the congestion manager 106 may reset the threshold of a token counter 110 associated with the congestion timer 112. Conversely, in one embodiment, if multiple congestion amelioration requests associated with the congestion timer 112 are received before the congestion timer 112 reached its threshold value, the congestion manager 106 may be configured to dynamically reduce the data rate controlled by the respective token counter 110.

It is understood that the above are merely a few illustrative examples of data rate management to which the subject matter of this disclosure is not limited. In various embodiments, the data rate management may be based upon prioritizing data transmitted by the various managed devices 192. In another embodiment, the data rate management may utilize managing a plurality of queues (not shown) of the apparatus 100. In one embodiment, the plurality of queues may be configured to facilitate the forwarding of information between the managed network 190 and the unmanaged network 198, via the respective interfaces 102 and 104. However, other data rate management schemes and techniques do exist within the scope of the disclosed subject matter. Furthermore, other network congestion amelioration schemes or techniques may exist that are based upon data rate management and are within the scope of the disclosed subject matter.

In one embodiment, the congestion manager 106 or, in another embodiment, the protocol manager 114 may be configured to request that some or all of managed devices 192 alter their behavior to ameliorate network congestion. In such an embodiment, when a network congestion amelioration request is received by the congestion manager 106, the congestion manager 106 may determine which managed devices 192 are contributing to the network congestion. In one embodiment, the network congestion amelioration request may be addressed or otherwise explicitly detail the managed devices 192 to which it pertains. In various embodiments, the congestion manager 106 may then communicate with the relevant managed devices 192 and instruct or request that they alter their behavior to assist in ameliorating the congestion. It is understood that communication with the managed devices 192 need not preclude the congestion manager 106 from taking independent action, as described above. In various embodiments, the apparatus 100 and managed devices may work together to ameliorate the network congestion.

In some embodiments, the congestion manager 106 may communicate with the managed devices 192 using a link layer; although it is understood that the above is merely a non-limiting illustrative example. In this context, a link layer may be a layer substantially in compliance with the second layer of the seven-layer Open Systems Interconnection Basic Reference Model (International Telecommunications Union, Open Systems Interconnection—Model and Notation X200, July 1994) or its derivatives or predecessors. Such a link layer may provide the functional and procedural ability to transfer data between network entities and to detect and possibly correct errors that may occur in the physical layer.

In one embodiment, the congestion manager 106 may include a protocol manager 114. In some embodiments, the protocol manager 114 may be configured to determine which congestion management protocols are supported by each of the plurality of managed devices 192. In one embodiment, this determination may occur via control signals exchanged when a managed device 192 is coupled with the apparatus 100. For example, in one embodiment, the control signals may inform the apparatus 100 of the network address and configuration or capabilities of the managed device 192. Example congestion management protocols may include, but are not limited to, priority-based flow control schemes, rate request based control schemes, congestion point or device initiated schemes, or transmission point or managed device initiated schemes (described below); although, it is understood that the above are merely a few illustrative examples to which the disclosed subject matter is not limited.

In one embodiment, the protocol manager 114 may be configured to determine a particular congestion management protocol to use to ameliorate the network congestion. In such an embodiment, the protocol manager 114 may be configured to base the determination, at least in part, upon the congestion management protocol(s) supported by a respective managed device 192. For example, in one embodiment, if the managed device 192 supports the same congestion protocol as the network congestion amelioration request received by the apparatus 100, the request may simply be forwarded to the managed device 192.

In one embodiment, the managed device 192 may support a priority-based flow control scheme; whereas, the received network congestion amelioration request may be based upon a rate-request-based control scheme. In such an embodiment, the congestion manager 106 may act to limit or dynamically adjust the data rate, as described above. The protocol manager 114 or congestion manger 106 may formulate and transmit a priority-based flow control scheme amelioration request to the managed device 192. In one embodiment, such a priority-based flow control scheme may include associating a priority with each piece of information transmitted from the managed device 192 (e.g., as a field in the data's header). Each priority may be associated with a different queue or data rate controlled by the managed device 192. In one embodiment, a priority-based flow control scheme request may include requesting that the data rate of data having a certain priority or group of priorities be reduced or halted for a period of time. As such, the congestion manager 106 may instruct or request that the managed device 192 may reduce the amount of data sent to the apparatus 100, based upon the priority level associated with the data being sent.

In another embodiment, the managed device 192 may not support a congestion point or device initiated scheme (e.g., a scheme in which the amelioration may be initiated by a device monitoring or experiencing the congestion), but instead may support a transmission point or managed device initiated scheme (e.g., a scheme in which the amelioration may be initiated by a transmitting device affected by the congestion). In such an embodiment, the protocol manager 114 or the congestion manager 106 may generate a set of conditions likely to cause the managed device 192 to initiate its network congestion amelioration scheme. For example, in the embodiment where the managed device 192 refrains from data transmission if receipt acknowledgments (e.g., data returned to the device indicating that the originally transmitted data was received) are not regularly returned to the managed device 192, the congestion manager 106 may withhold receipt acknowledgement notices from the managed device 192; although it is understood that the above is merely an illustrative example to which the disclosed subject matter is not limited.

In yet another embodiment, some managed devices 192 may not be capable of performing any network congestion amelioration or at least not capable of using any scheme known to the congestion manager 106 or the protocol manager 114. In such an embodiment, the congestion manager 106 may act independently to ameliorate the congestion. It is understood that the above are merely a few illustrative examples to which the disclosed subject matter is not limited.

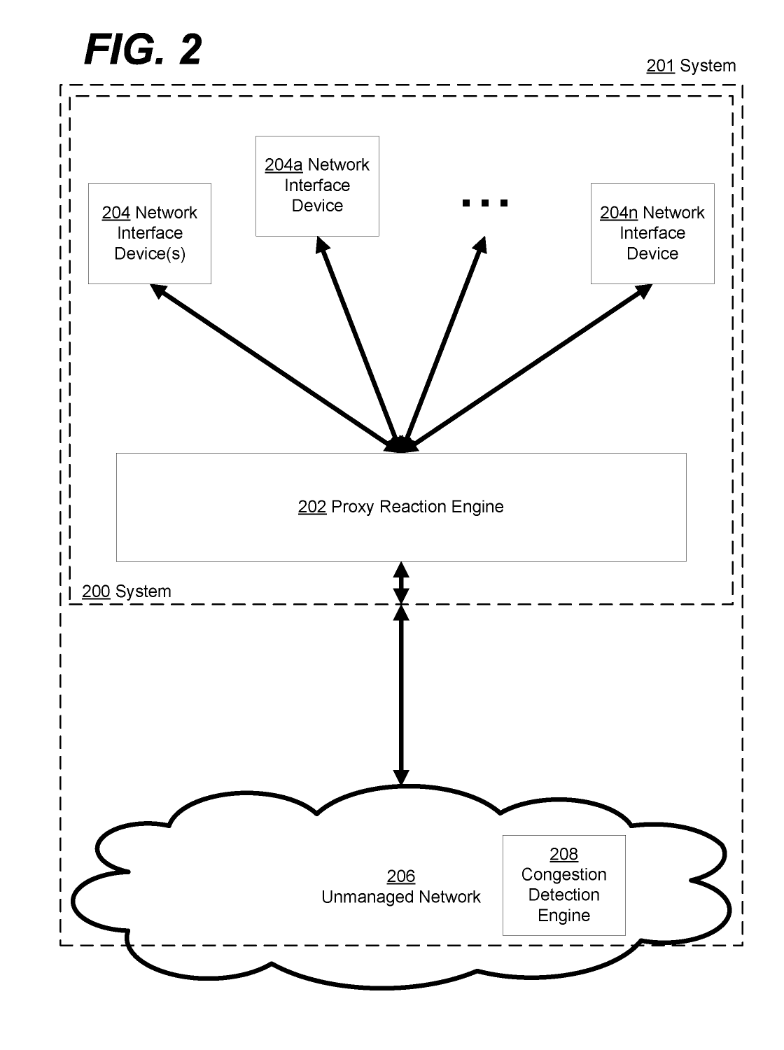

FIG. 2 is a block diagram of a system for the amelioration of congestion in a network in accordance with the disclosed subject matter. In one embodiment, the system 200 may include a proxy reaction engine 202 and a plurality of network interface devices (e.g., network interface devices 204, 204a, and 204n). In one embodiment, the proxy reaction engine 202 may include an edge device (e.g., a switch, a router, etc.). In various embodiments, the edge device may be configured to provide an entry/exit point into an enterprise or service provider level network from a faster backbone or core network, and may translate between one type of network protocol to another. In one embodiment, the network interface device 204 may include a network interface card or controller configured to allow a network capable device access to a computer network (e.g., the Internet, an intranet, a wireless network, a cellular network, etc.).

In one embodiment, the plurality of network interface devices 204 may be configured to communicate data with an unmanaged network 206. In one embodiment, the plurality of network interface devices 204 may also be configured to communicate data amongst themselves and other devices not included within the unmanaged network 206. In various embodiments, the plurality of network interface devices 204 may be configured to manage a queue of data to be communicated with the unmanaged network 206.

In one embodiment, the proxy reaction engine 202 may be configured to manage the rate of data communicated between the plurality of network interface devices 204 and the unmanaged network 206, as described above. In one embodiment, the proxy reaction engine 202 may be configured to dynamically adjust the rate of data communicated based at least in part upon a network congestion amelioration request received from the unmanaged network 206, as described above. In one embodiment, the proxy reaction engine 202 may include the apparatus 100 of FIG. 1.

In one embodiment, the system 201 may include a proxy reaction engine 202, a plurality of network interface devices (e.g., network interface devices 204, 204a, and 204n), and a congestion detection engine 208. In one embodiment, the unmanaged network 206 may include the congestion detection engine 208.

In one embodiment, the congestion detection engine 208 may be configured to monitor and detect network congestion within the unmanaged network 206. In some embodiments, the congestion detection engine 208 may be an intermediate device (e.g., a switch) along a route data may take from the managed device 204 to a destination device (not shown). In one embodiment, the congestion detection engine 208 may be configured to transmit a network congestion amelioration request to the proxy reaction engine 202. In one such embodiment, the network congestion amelioration request may be transmitted to a network interface device 204, via the proxy reaction engine 202.

In various embodiments, some or all of the network interface devices 204 may not be configured to receive or process the network congestion amelioration request transmitted by the congestion detection engine 208. In such an embodiment, without the proxy reaction engine 202 the amelioration request may go unheeded and fail. In various embodiments, the amelioration request may be intercepted and handled by the proxy reaction engine 202, as described above. In such an embodiment, the proxy reaction engine 202 may provide congestion amelioration without the need to simultaneously upgrade or replace the plurality of network interface devices 204 to versions that are compatible with the congestion detection engine 208. In one embodiment, the proxy reaction engine 202 may allow networking systems to deploy a congestion management scheme without requiring all endpoints (e.g., the source and destination of transmitted data) to be upgraded or replaced. In various embodiments, this may enable a deployment model where if the proxy reaction engine 202 is replaced or upgraded, a new congestion management scheme could immediately be utilized without needing to wait for all network interface devices 204 to be replaced or upgraded as well.

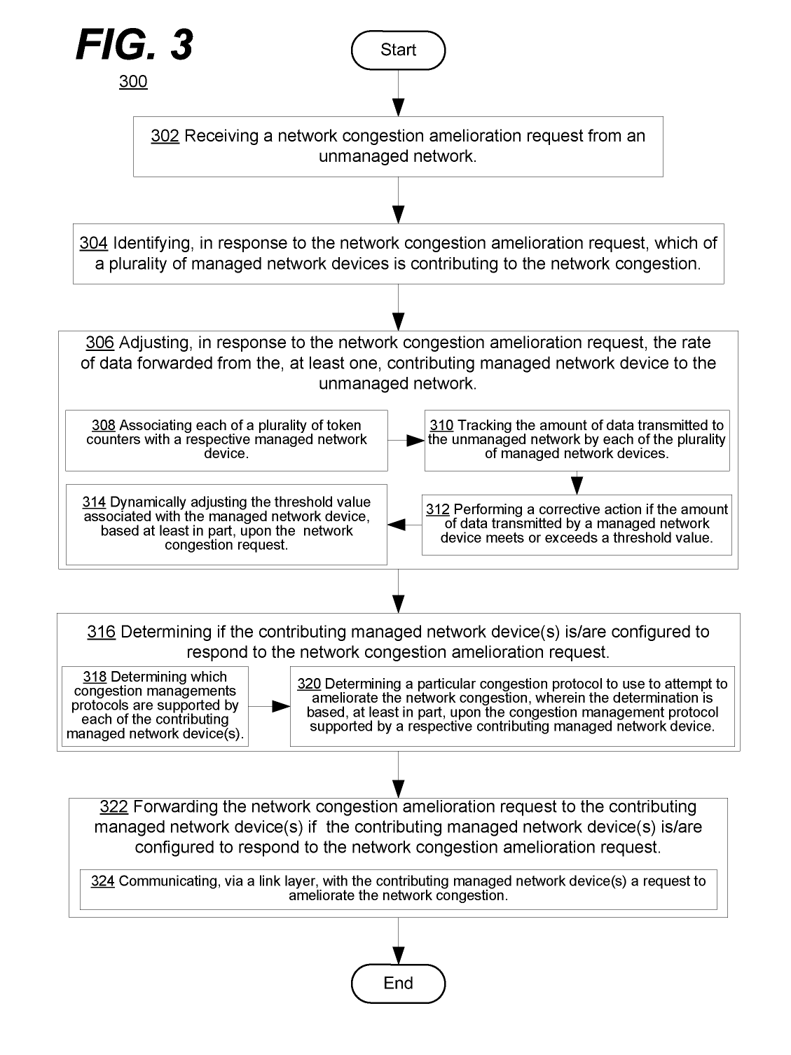

FIG. 3 is a flowchart of a technique 300 for the amelioration of congestion in a network in accordance with the disclosed subject matter. Block 302 illustrates that, in one embodiment, a network congestion amelioration request may be received from an unmanaged network. In one embodiment, the request may be received from a congestion manager 106 or an unmanaged network interface 104 of FIG. 1, as described above. In another embodiment, the request may be received by a proxy reaction engine 202 of FIG. 2, as described above. In one embodiment, the request may be sent by a congestion detection engine 208 of FIG. 2, as described above.

Block 304 illustrates that, in one embodiment, an identification may occur of which devices of a plurality of managed network devices are contributing to the network congestion. In various embodiments, the amelioration request may include the network address(es) of the contributing device(s). In one embodiment, the congestion manager 106 or the unmanaged network interface 104 of FIG. 1 may identify the contributing device(s), as described above.

Block 306 illustrates that, in one embodiment, the rate of data forwarded from the contributing managed network device to the unmanaged network may be adjusted, in response to the network congestion amelioration request. In one embodiment, the congestion manager 106 of FIG. 1 may adjust the data rate, as described above.

Block 308 illustrates that, in one embodiment, each of a plurality of token counters may be associated with a respective managed network device. In one embodiment, the congestion manager 106 of FIG. 1 may make these associations, as described above.

Block 310 illustrates that, in one embodiment, the amount of data transmitted, by the plurality of managed network devices to the unmanaged network, may be tracked or counted. In one embodiment, the congestion manager 106 or the token counters 110 of FIG. 1 may track the data rate of the managed devices, as described above.

Block 312 illustrates that, in one embodiment, if the amount of data exceeds or equals a certain threshold a corrective action may be taken. In various embodiments, the corrective action may include halting or reducing further transmission of data for a period of time, as described above. In a specific embodiment, if a managed network device attempts to transmit more data than its assigned data rate permits, transmission of further data may be halted until the managed network device is brought below the assigned data rate. In one embodiment, the congestion manager 106 or the token counters 110 of FIG. 1 may perform the corrective action, as described above.

Block 314 illustrates that, in one embodiment, the threshold value may be dynamically adjusted based at least in part upon the received network congestion amelioration request. It is understood that adjustments to either increase or decrease the threshold value are within the scope of the disclosed subject matter. Furthermore, the threshold may be decreased and then later increased, as described above. In one embodiment, the congestion manager 106 or the token counters 110 of FIG. 1 may adjust the threshold, as described above. In one embodiment, the congestion timer 112 of FIG. 1 may influence or contribute to the adjustment of the threshold, as described above.

Block 316 illustrates that, in one embodiment, a determination may be made as to which (if any) of the plurality of managed network devices are configured to or capable of responding to the network congestion amelioration request. In one embodiment, the congestion manager 106 or the protocol manager 114 of FIG. 1 may make the determination, as described above.

Block 318 illustrates that, in one embodiment, a determination may be made as to which (if any) congestion management protocols or schemes are supported by each of the plurality of managed network devices. In one embodiment, the congestion manager 106 or the protocol manager 114 of FIG. 1 may make the determination, as described above.

Block 320 illustrates that, in one embodiment, a determination may be made as to which (if any) congestion management protocol or scheme to use when requesting assistance from a particular managed network device. In one embodiment, the congestion manager 106 or the protocol manager 114 of FIG. 1 may make the determination, as described above.

Block 322 illustrates that, in one embodiment, the network congestion amelioration request may be forwarded to the contributing managed network devices (identified in Block 304) that are configured to respond to the network congestion amelioration request. In various embodiments, amelioration assistance may be requested from the contributing managed network devices using a congestion protocol or scheme dissimilar from the network congestion amelioration request, as described above. In one embodiment, the congestion manager 106 or the protocol manager 114 of FIG. 1 may forward the request, as described above.

Block 324 illustrates that, in one embodiment, the communication with the contributing managed network devices may include use of a link layer, as described above. In one embodiment, the congestion manager 106 or the managed network interface 102 of FIG. 1 may communicate with the contributing managed network devices, as described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a variety of components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. An apparatus comprising:
a managed network interface configured to receive data from and transmit data to a managed network, wherein the managed network comprises a plurality of managed devices configured to queue and transmit data;
an unmanaged network interface configured to receive data from and transmit data to an unmanaged network, wherein the unmanaged network is configured to request the amelioration of network congestion experienced by the unmanaged network; and
a congestion manager configured to:
receive a network congestion amelioration request from the unmanaged network,
ameliorate network congestion by controlling the rate of information forwarded from the managed network to an unmanaged network, and
dynamically alter the rate of information forwarded from the managed network to the unmanaged network.

2. The apparatus of claim 1 wherein the congestion manager comprises:
a plurality of token counters wherein each token counter is configured to be associated with a managed device, wherein the token counter is configured to manage the rate of information forwarded from the managed device to the unmanaged network, and
the token counter comprises a threshold configured to limit the rate of the information forwarded from the managed device to the unmanaged network.

3. The apparatus of claim 2 wherein the congestion manager is configured to dynamical alter the threshold of the token counter based, at least in part upon, the congestion amelioration request from the unmanaged network.

4. The apparatus of claim 1 wherein the congestion manager comprises a congestion timer, wherein the congestion timer is configured to measure a time between congestion amelioration requests from the unmanaged network; and
wherein the congestion manager is configured to:
once the congestion timer reaches a threshold, reset the rate of information forwarded from the managed network to an unmanaged network.

5. The apparatus of claim 2 wherein each piece of information comprises a priority,
wherein each token counter is also associated with a priority, and
wherein each token counter is configured to limit the rate of information with the associated priority forwarded from the managed device to the unmanaged network.

6. The apparatus of claim 2 wherein the congestion manager comprises:
a plurality of congestion timers, each congestion timer being associated with a managed device;
wherein each congestion timer is configured to:
measure a time between congestion amelioration requests associated with the managed device, and,
once the congestion timer reaches a threshold, to reset the threshold of a token counter associated with the same managed device as the congestion timer.

7. The apparatus of claim 1 wherein the congestion manager comprises:
a protocol manager configured to:
determine which congestion management protocols are supported by each of the plurality of managed devices; and
determine a particular congestion protocol to use to ameliorate the network congestion, wherein the determination is based, at least in part, upon the congestion management protocol supported by a respective managed device.

8. The apparatus of claim 7 wherein the congestion manager is configured to, if a managed device supports priority-based flow control, instructing the managed device to alter the rate of information transmitted by the managed device based upon a priority level associated with the information.

9. The apparatus of claim 1 wherein the congestion manager is configured to:
communicate, via a link layer, with the managed devices, and
request that the managed devices alter their behavior to ameliorate network congestion.

10. A system comprising:
a plurality of network interface devices; and
a proxy reaction engine;
wherein each network interface device is configured to:
communicate data with an unmanaged network, and
manage a queue of data to be communicated with the unmanaged network; and
wherein the proxy reaction engine is configured to:
manage the rate of data communicated between the plurality of network interface devices and the unmanaged network, and
dynamically adjust the rate of data communicated based at least in part upon a network congestion amelioration request received from the unmanaged network.

11. The system of claim 10 wherein the proxy reaction engine comprises:
a managed network interface configured to communicate with the plurality of network interface devices;
an unmanaged network interface configured to communicate with the unmanaged network; and
a congestion manager configured to:
receive a network congestion amelioration request from the unmanaged network, and
ameliorate network congestion by controlling the rate of information forwarded from the plurality of network interface devices to the unmanaged network.

12. The system of claim 11 wherein the congestion manager comprises:
a plurality of token counters wherein each token counter is configured to be associated with a network interface device, wherein the token counter is configured to manage the rate of information forwarded from the network interface device to the unmanaged network, and
the token counter comprises a threshold configured to limit the rate of the information forwarded from the network interface device to the unmanaged network.

13. The system of claim 11 wherein the congestion manager comprises a congestion timer, wherein the congestion timer is configured to measure a time between congestion amelioration requests from the unmanaged network; and
wherein the congestion manager is configured to:
once the congestion timer reaches a threshold, reset the rate of information forwarded from the plurality of network interface devices to an unmanaged network.

14. The system of claim 12 wherein the congestion manager comprises:
a plurality of congestion timers, each congestion timer configured to be associated with a network interface device;
wherein each congestion timer is configured to:
measure a time between congestion amelioration requests associated with the network interface device, and,
once the congestion timer reaches a threshold, to reset the threshold of a token counter associated with the same network interface device as the congestion timer.

15. The system of claim 11 wherein the congestion manager comprises:
a protocol manager configured to:
determine which congestion management protocols are supported by each of the plurality of network interface devices; and
determine a particular congestion protocol to use to ameliorate the network congestion, wherein the determination is based, at least in part, upon the congestion management protocol supported by a respective network interface device.

16. The system of claim 1 wherein the proxy reaction engine is configured to:
communicate, via a link layer, with the network interface devices, and
request that the network interface devices alter their behavior to ameliorate network congestion.

17. A method comprising:
receiving a network congestion amelioration request from an unmanaged network;
identifying, in response to the network congestion amelioration request, which of a plurality of managed network devices is contributing to the network congestion;
adjusting, in response to the network congestion amelioration request, the rate of data forwarded from the, at least one, contributing managed network device to the unmanaged network;
determining if the contributing managed network device(s) is/are configured to respond to the network congestion amelioration request; and
forwarding the network congestion amelioration request to the contributing managed network device(s) if the contributing managed network device(s) is/are configured to respond to the network congestion amelioration request.

18. The method of claim 17 wherein adjusting the rate of data comprises:
associating each of a plurality of token counters with a respective managed network device;
tracking the amount of data transmitted to the unmanaged network by each of the plurality of managed network devices;
performing a corrective action if the amount of data transmitted by a managed network device exceeds a threshold value; and
dynamically adjusting the threshold value associated with the managed network device, based at least in part, upon the network congestion request.

19. The method of claim 17 wherein determining if the contributing managed network device(s) is/are configured to respond to the network congestion amelioration request comprises:
determining which congestion managements protocols are supported by each of the contributing managed network device(s); and
determining a particular congestion protocol to use to attempt to ameliorate the network congestion, wherein the determination is based, at least in part, upon the congestion management protocol supported by a respective contributing managed network device.

20. The method of claim 17 wherein forwarding the network congestion amelioration request comprises:
communicating, via a link layer, with the contributing managed network device(s) a request to ameliorate the network congestion.
